(19) United States
(12) Patent Application Publication
(10) Pub. No.: US 2010/0143816 A1
(43) Pub. Date: Jun. 10, 2010

(54) FUEL CELL SYSTEM WITH SENSOR FOR DETECTING PRESSURE FLUCTUATIONS IN A FLUID SUPPLY TRAIN

(76) Inventors: Eduard Saar, Steinheim (DE); Ulrich Gottwick, Stuttgart (DE); Jens Intorp, Stuttgart (DE); Daniel Zirkel, Krickenbach (DE); Juergen Binder, Filderstadt-Plattenhardt (DE); Gunter Wiedemann, Ludwigsburg (DE); Frank Ilgner, Stuttgart (DE); Jan-Michael Graehn, Stuttgart (DE); Thomas Fischer, Tamm (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/524,624

(22) PCT Filed: Dec. 28, 2007
(86) PCT No.: PCT/EP07/64610

§ 371 Date: Jul. 27, 2009

(30) Foreign Application Priority Data
Jan. 29, 2007 (DE) 10 2007 004 347.5

(51) Int. Cl. H01M 8/04

(52) U.S. Cl. 429/446; 429/513

(57) ABSTRACT

The present invention relates to a fuel cell system with a fluid supply element and/or fluid control element. The fuel cell system includes a fuel cell, an anode train, and a cathode train. The fluid supply element and fluid control elements are disposed within the anode train and/or the cathode train. A sensor for detecting pressure fluctuations and/or pressure peaks in a fluid supply train of the anode and/or the cathode is provided.

The present invention relates to a fuel cell system as generically defined by the preamble to claim 1.

### PRIOR ART

For supplying fuel cell systems on the anode side, these systems include a first fluid supply train that delivers the fuel. The supply on the cathode side is effected via a second fluid supply train, by way of which the oxygen required for operating the fuel cell is furnished as a rule by the delivering ambient air.

For the sake of adequate supply to the fuel cell, the system typically delivers not only the fuel but also the air that transports the oxygen at overpressure. This commonly causes pressure fluctuations in one or the other fluid supply train, and as a result the fuel cell system is sometimes subjected to severe stresses.

### OBJECT AND ADVANTAGES OF THE INVENTION

It is therefore the object of the present invention to improve a fuel cell system of the type defined at the outset.

This object is attained by the characteristics of claim 1. Advantageous and expedient refinements of the invention are disclosed in the dependent claims.

Accordingly, the present invention relates to a fuel cell system having fluid supply and/or fluid control elements. They are distinguished in that a sensor is provided for detecting pressure fluctuations and/or pressure peaks in a fluid supply train.

This fluid supply train may be either the supply train on the cathode side or the supply train on the anode side. In both of them, pressure fluctuations can occur, and by monitoring or detecting them, suitable countermeasures can be initiated.

Such fluctuations in the fluid supply train involve not only the usual pressure fluctuations resulting from operation itself, but also pressure fluctuations that are independent of operation. They can be engendered for instance by rapid changes in the flow behavior of the applicable medium, such as so-called “compressor pumping” in which a sudden rupture in the flow occurs. Other sudden pressure fluctuations can be tripped by overly rapid valve switching events.

The best possible monitoring of the flow behavior in the fluid supply train can therefore be achieved by associating a sensor with a fluid supply and/or fluid control element. As a result, these especially critical, often sudden pressure fluctuations in the fuel cell system can be detected in the immediate vicinity of the source. Because of this closeness, better evaluation of the signals to be detected is possible; interference signals are as a rule detected with comparatively weakened amplitudes because of the longer transmission distances, so that the signal to be detected can be distinguished better from them.

Especially for early or advance detection of flow ruptures in a fluid compressor, such as a turbine compressor, and/or a control valve, a direct association of a sensor is especially advantageous. Thus specifically, even fluctuations in the fluid supply train that occur typically before the actual flow rupture can be detected and suitable countermeasures can be initiated.

In an especially preferred embodiment, the sensor is embodied as a sound sensor. Thus the pressure fluctuations in a fluid supply train can be detected in the form of structure-borne sound. Accordingly, the sensor need not necessarily be in fluidic contact with the fluid supply train. A connection with the fluid supply and/or fluid control element to be monitored that is a good conductor of sound is sufficient.

It is furthermore advantageous to monitor not only the fluid compressor but also metering elements, such as switching valves which are often used in the anode gas supply train for metering the delivery of fuel, with regard to their effect on the pressure system in the fluid supply train.

In an especially preferred embodiment, as the sensor, a knocking sensor is provided. This kind of sound sensor, based as a rule on piezoelectric sensor elements and a seismic mass, is known to furnish reliably evaluatable signals for detecting knocking sounds in internal combustion engines.

By means of a control unit, such signals can furthermore be detected and evaluated. Optionally in collaboration with other detection means, such as a pressure sensor, and/or a sensor for detecting pressure fluctuations and/or pressure peaks in a fluid, and/or an air flow rate meter, the operating state of the fuel cell system can be detected even more comprehensively.

On the basis of the data detected, at least those of the sensor of the invention, it is even possible to conclude whether critical pressure fluctuations in a fluid supply train the fuel cell system are to be expected immediately, so that suitable avoidance measures can initiated possibly even before such pressure fluctuations occur.

Thus not only the most-sensitive elements in the fuel cell system, that is, the diaphragm and the typically very thin electrically conductive films in the electrolyte, thus the other components of the fuel cell system as well can be protected against excessive mechanical stresses.

A further advantage of using such a sensor to eliminate pressure fluctuations is that the affected components of the fuel cell system can be operated as close as possible to the operating point at which the critical pressure fluctuations begin to occur in the respective fluid supply train. Because it is thus possible to operate the various components up to their limits, these components, given known stress requirements, can be constructed less strongly and unnecessary safety margins can be dispensed with, since system-critical pressure fluctuations and/or pressure peaks can be reliably suppressed.

### EXEMPLARY EMBODIMENT

The invention is described in further detail below in conjunction with the drawings.

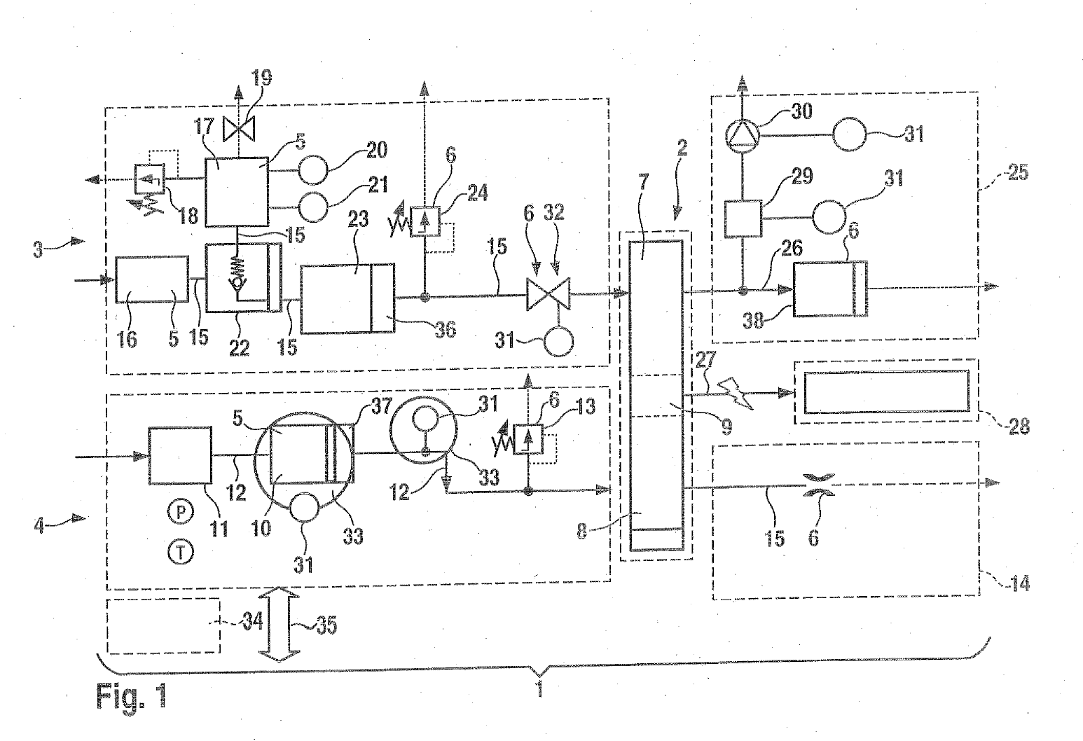

FIG. 1 shows as an example a schematic illustration of a fuel cell system with a sensor for detecting pressure fluctuations in a fluid supply train.

In detail, FIG. 1 shows a fuel cell system 1, which includes a fuel cell 2 with an anode train 3 and a cathode train 4.

The fuel cell 2 essentially includes an anode 7, a cathode 8, and a diaphragm 9 separating the two.

For supplying oxygen to the cathode 8, a compressor 10, taking a fluid supply element 5 as an example, is shown in the cathode train. Via the filter 11, this element aspirates the air, compresses it, and makes it available to the cathode 8 via the lines 12 inside the pressure region monitored by the safety valve 13. On the outlet side, the cathode residual gas unit 14 is shown, with a line 15 shown in it.

For supplying the anode with fuel, a fluid supply element 5 in the form of a pressure tank 17 in the system is shown in the anode train 3, and this tank itself can be filled via a tank coupling 16. Examples of elements connected to the pressure tank 17 are a safety valve 18, a fuse 19, a temperature sensor 20, and a pressure sensor 21.

Via lines 15, an interposed blocking valve 22, and a pressure reducer 23 connected downstream in the flow direction, the fuel supply path communicates fluidically with the anode 7. For monitoring the highest allowable operating pressure therein, a safety valve 24 is also integrated downstream of the pressure reducer 23. By means of a switching valve 32, also shown as an example, influence can additionally be exerted on this fluid flow.

On the anode output side, an anode residual gas unit 25 is shown as an example, with lines 26 and a so-called purge valve (outlet valve) 38.

To improve the efficiency of the fuel system 1, an anode residual gas compressor 29 and a recirculating pump 30 can be provided in the anode residual gas unit 25, in order to compress the residual gas and deliver it to an intermediate reservoir, not shown in detail, for further use.

The electrical connection of the fuel cell system 1 is also shown as an example by way of the electrical terminal 27 and the on-board electrical network 28.

According to the invention, at least one sensor 31 is provided, for detecting pressure fluctuations and/or pressure peaks in a fluid supply train 3, 4. Especially advantageously, such a sensor 31 is associated directly with a fluid supply and/or fluid control element 5, 6. For example, this may be a compressor 10 in the air supply of the cathode train 4, a control valve 32 in the anode train 3, or elements of the anode residual gas unit 25, such as a purge valve 38, an anode residual gas compressor 29, and/or a recirculating pump 30. So-called turbine compressors are especially suitable as the fluid compressors. Such turbine compressors shovel the air with so-called guide baffles, and the flow ruptures which generate pressure peaks and which are to be monitored by the sensor disposed according to the invention can occur especially at high rpm.

The sensor 31 is embodied as a sound sensor and is intended especially preferably for detecting structure-borne sound. Especially advantageously, the sound sensor is therefore connected in a manner that conducts structure-borne sound to the unit to be monitored of the fuel cell system. In an especially preferred embodiment, the sensor is embodied as a knocking sensor, which may be designed for instance with a seismic mass and a piezoelectric ceramic element.

For the sake of clearly showing a preferably predominantly local monitoring, especially for reducing interference levels, two circuits 33 as an example are shown as a detection region in the cathode train 4 for the pressure fluctuations and/or pressure peaks to be detected by way of structure-borne sound. For the sake of simplicity, further illustrations of such detection regions 33 with regard to the other components to be monitored have been dispensed with.

The processing of the signals detected by one or more such sensors 31 can be done via a control unit 34, which especially advantageously detects these signals, processes them, and optionally initiates provisions for avoiding critical pressure fluctuations, especially critical pressure peaks, in one or both of the fluid supply trains 3, 4 to be monitored. This can be effected for instance via a reduction in the rpm of the compressor, gentler valve triggering, and the like.

For still more-comprehensive detection of operating parameters of the fuel cell system 1, signals of a temperature sensor 20, a pressure sensor 21, a sensor 36 for detecting pressure fluctuations and/or pressure peaks in a fluid, and/or an air flow rate meter 37 as well may be provided. The positions shown for these in FIG. 1 are shown only as examples and can certainly be provided at other suitable places or additional ones as well as in different combinations.

To make external data pickup and data access available, a connection 35 is furthermore shown as an example.

1-10. (canceled)

11. A fuel cell system comprising:
a fuel cell having an anode and a cathode;
a fluid supply train for each of the anode and the cathode;
fluid supply elements and/or fluid control elements provided in one or both of the fluid supply trains; and
at least one sensor which detects pressure fluctuations in the fluid supply trains.

12. The fuel cell system as defined by claim 11, wherein the sensor is associated with a fluid supply and/or fluid control element.

13. The fuel cell system as defined by claim 11, wherein the sensor is associated with a fluid compressor and/or a control valve.

14. The fuel cell system as defined by claim 12, wherein the sensor is associated with a fluid compressor and/or a control valve.

15. The fuel cell system as defined by claim 13, wherein the fluid compressor is a turbine compressor.

16. The fuel cell system as defined by claim 14, wherein the fluid compressor is a turbine compressor.

17. The fuel cell system as defined by claim 11, wherein the sensor is a sound sensor.

18. The fuel cell system as defined by claim 12, wherein the sensor is a sound sensor.

19. The fuel cell system as defined by claim 13, wherein the sensor is a sound sensor.

20. The fuel cell system as defined by claim 15, wherein the sensor is a sound sensor.

21. The fuel cell system as defined by claim 17, wherein the sensor detects structure-borne sound.

22. The fuel cell system as defined by claim 17, wherein the sensor detects structure-borne sound.

23. The fuel cell system as defined by claim 19, wherein the sensor detects structure-borne sound.

24. The fuel cell system as defined by claim 20, wherein the sensor detects structure-borne sound.

25. The fuel cell system as defined by claim 11, wherein the sensor is a knocking sensor.

26. The fuel cell system as defined by claim 11, further comprising a control unit.

27. The fuel cell system as defined by claim 14, further comprising a control unit.

28. The fuel cell system as defined by claim 11, further comprising a pressure sensor.

29. The fuel cell system as defined by claim 27, further comprising a pressure sensor.

30. The fuel cell system as defined by claim 11, further comprising an air flow rate meter.
